(19) United States
(12) Patent Application Publication
(10) Pub. No.: US 2019/0089441 A1
(43) Pub. Date: Mar. 21, 2019

(54) METHOD AND SYSTEM FOR MIMO COMMUNICATION

(71) Applicant: NEC Corporation, Minato-ku, Tokyo (JP)

(72) Inventor: Thirukkumaran SIVAHUMARAN, Victoria (AU)

(73) Assignee: NEC Corporation, Minato-ku, Tokyo (JP)

(21) Appl. No.: 15/509,598

(22) PCT Filed: Sep. 30, 2015
(86) PCT No.: PCT/JP2015/004973

§ 371 Date: Mar. 8, 2017

(30) Foreign Application Priority Data
Oct. 1, 2014 (AU) 2014903904

(51) Int. Cl. H04B 7/06; H04B 7/0456; H04L 25/02

(52) U.S. Cl. CPC H04B 7/0639; H04B 7/0478; H04B 7/0626; H04L 25/0204; H04B 7/063

(57) ABSTRACT

A method and system for data communication is provided. The wireless communication system including a base station comprising a plurality of antennas arranged in an array of at least two dimensions. The method includes receiving, at a user equipment (UE) and from a set of the plurality of antennas, a plurality of reference signals, wherein the set of antennas includes antennas arranged in two spatial dimensions; deriving channel estimates based on at least one received reference signal of plurality of reference signals; selecting at the UE based on the channel estimates, a precoding matrix from at least one configurable precoding codebook by applying an associated configurable precoder function to matrices in the configurable precoding codebook; and transmitting, from the UE to the base station, the channel information wherein the channel information includes an identifier of the selected precoding matrix.

### CROSS-REFERENCE TO RELATED APPLICATION

This application is a National Stage Entry of PCT/JP2015/004973 filed on Sep. 30, 2015, which claims priority from Australian Patent Application 2014903904 filed on Oct. 1, 2014, the contents of all of which are incorporated herein by reference, in their entirety. The present invention relates to control signalling in advanced wireless communication networks. In particular, although not exclusively, the invention relates to reporting of channel information and generation of precoders in MIMO systems.

### TECHNICAL FIELD

The following abbreviations are used herein:

| | |
|---|---|
| 2D | 2 Dimension |
| 3D | 3 Dimension |
| 3GPP | 3rd Generation Partnership Project |
| BF | Beamforming |
| CoMP | Co-ordinated Multi Point |
| CQI | Channel Quality Information |
| CSI | Channel State Information |
| DL | Down Link |
| DMRS | DeModulation Reference Signal |
| eNB/eNodeB | enhanced NodeB |
| FDD | Frequency Domain Duplex |
| FD-MIMO | Full Dimension - MIMO |
| LTE | Long Term Evolution |
| LTE-A | LTE Advanced |
| MIMO | Multiple Input Multiple Output |
| MU-MIMO | Multi-user MIMO |
| PMI | Precoding Matrix Index |
| PTI | Precoding Type Indicator |
| QPSK | Quadrature Phase Shift Keying |
| RF | Radio Frequency |
| RI | Rank Indicator |
| RS | Reference Signal |
| TDD | Time Domain Duplex |
| TM | Transmission Mode |
| TP | Transmission Point |
| UE | User Equipment |
| UL | Up Link |
| ULA | Uniform Linear Array |
| URA | Uniform Rectangular Array |

### BACKGROUND ART

Wireless communication systems are widely known in which base stations (also known as eNodeBs (eNBs)) communicate with mobile devices (also known as user equipments (UEs)) which are within range of the eNB. Each eNB divides its available bandwidth, i.e. frequency and time resources, into different resource allocations for the different UEs. There is a constant need to increase the capacity of such systems, and to improve the efficiency of resource utilisation, in order to accommodate more users (more UEs), more data-intensive services and/or higher data transmission rates.

OFDM (Orthogonal Frequency Division Multiplexing) is one technique used for transmitting data in wireless communication systems. An OFDM-based communications scheme divides data symbols to be transmitted among a large number of subcarriers; hence the term “frequency division multiplexing.” Data is modulated onto a subcarrier by adjusting its phase, amplitude, or both phase and amplitude. The “orthogonal” part of the name OFDM refers to the fact that the spacings of the subcarriers in the frequency domain are chosen so as to be orthogonal, in a mathematical sense, to the other subcarriers. In other words, they are arranged in the frequency domain such that the sidebands of adjacent subcarriers may overlap but such that inter-subcarrier interference is sufficiently minimised for the subcarriers to be received.

When individual subcarriers or sets of subcarriers are assigned to different users (different UEs), the result is a multi-access system referred to as OFDMA (Orthogonal Frequency Division Multiple Access). The term OFDM is often intended to include OFDMA. The two terms may therefore be considered interchangeable for the purposes of the present explanation. By assigning distinct frequency/time resources to each UE in a cell, OFDMA can help to avoid interference among UEs within a given cell.

A further modification of the basic OFDM scheme is called MIMO which stands for “multiple-input multiple-output.” This type of scheme employs multiple antennae at the transmitter and/or at the receiver (often at both) to enhance the data capacity achievable between the transmitter and the receiver. Typically, this is used to achieve enhanced data capacity between an eNB and the user equipment(s) (UE(s)) served by that eNB.

By way of example, a 2×2 “single user MIMO” (SU-MIMO) configuration contains two antennae at the transmitter and two antennae at a single receiver that is in communication with the transmitter. Likewise, a 4×4 SU-MIMO configuration contains four antennae at the transmitter and four antennae at the single receiver that is in communication with the transmitter. There is no need for the transmitter and receiver to employ the same number of antennae. Typically, an eNB in a wireless communication system will be equipped with more antennae in comparison with a UE, owing to differences in power, cost and size limitations. It should also be noted that so called “multi-user MIMO” (MU-MIMO) is often employed, and this involves a single eNB which is able to perform MIMO communication with multiple UEs at once. This is discussed further below.

The term “channel” is commonly used to refer to the frequency (or equivalently time delay) response of the radio link between a transmitter and a receiver. The MIMO channel (hereafter simply the “channel”) contains all the subcarriers (see the discussion on subcarriers above), and covers the whole bandwidth of transmission. A MIMO channel contains many individual radio links. The number of these individual radio links, which may each be individually referred to as a single-input single-output (SISO) channel, is N_{RX}×N_{TX}, where N_{TX} is the number of antennae at the transmitter and N_{RX} is the number of antennae at the receiver(s). For example, a 3×2 SU-MIMO arrangement contains 6 links, hence it has 6 SISO channels.

The following explanation will be given in the present application solely for better understanding the technology, and not as admission of prior art. Considering the simplified 2×3 SU-MIMO system schematically represented in FIG. 1, it can be seen that antenna R0 of receiver R receives transmissions from each of the transmitter antennae T0, T1 and T2 of transmitter T. Similarly, receiver antenna R1 receives transmissions from transmitter antennae T0, T1 and T2. Therefore, the signal received at the receiver comprises (or is made up of) a combination of the transmissions (i.e. a combination of the six SISO channels) from the transmitter antennae. In general, SISO channels can be combined in various ways to transmit one or more data streams to the receiver.

FIG. 2 is a conceptual diagram of a more generalized SU-MIMO system. In FIG. 2, a transmitter transmits signals utilizing N_{TX} transmitting antennae, and a single receiver receives the signals from the transmitter utilizing N_{RX} receiving antennae. In order to create a mathematical model of the characteristics of the overall MIMO channel (in this case a SU-MIMO channel), it is necessary to represent the individual SISO channels between the transmitter and receiver. As shown in FIG. 2, the individual SISO channels are represented by H_{0,0} to H_{N}_{_{RX-1}}_{,N}_{_{TX-1}}, and as suggested in the Figure, these form terms of a matrix commonly called the “channel matrix” or channel response matrix H. It will be recognised that H_{0,0} represents the channel characteristics (for example, channel frequency response) for transmitting signals from transmitting antenna 0 to receiving antenna 0. Similarly, “H_{N}_{_{RX-1}}_{,N}_{_{TX-1}}” represents the channel characteristics for transmitting signals from the transmitting antenna N_{TX-1} to the receiving antenna N_{RX-1}, and so on.

In FIG. 2, the symbols x₀ to x_{N}_{_{TX-1}}, which represent the signal elements transmitted using the transmitting antennae 0 to N_{TX-1} together form a transmitted signal vector

x=(x₀, x₁, . . . , x_{N}_{_{TX-1}})^{T}, where ( )^{T} indicates the vector transpose. Likewise, the received signals elements
y₀ to y_{N}_{_{RX-1}} received by receiving antennae 0 to N_{RX-1} together form received signal vector y=(y₀, y₁, . . . , y_{N}_{_{RX-1}})^{T}. The relationship between the vectors y and x for the simplified single user system shown in FIG. 2 may be modelled by the basic MIMO system equation:

y=Hx+n (Equation 0)

where H is the channel matrix referred to above and n is a vector representing noise (usually assumed to be additive white Gaussian noise).

One of the MIMO technologies that have been used in cellular systems such as 3GPP LTE/LTE-A is closed loop transmit precoding. FIG. 3 illustrates a system 10 including a closed loop transmit precoding capable base station 12 and a UE 14. The base station 12 can digitally adjust a transmission beam 16 horizontally to adapt changes in conditions caused by movement of the UE 14, or variation in environmental conditions within a cell.

In particular, channel state information (CSI) is obtained at the base station 12 and is used to precode data before being modulated and transmitted from antennas of the base station 12. The base station 12 transmits downlink (DL) reference signal(s) from its designated antenna ports which are used by the UE 14 to calculate CSI. The CSI is then encoded and fed back to the base station 12 using either an UL control channel or by multiplexing on an UL data channel. At the base station 14, the received feedback CSI information is decoded and used to calculate precoding information. This precoding information is then applied to the DL data channel before transmission from the antenna ports.

In 3GPP LTE/LTE-A, transmission modes TM4, TM5, TM6, TM8, TM9 and TM10 have been defined for supporting closed loop transmit precoding. In LTE TDD mode, the base station performs transmission and reception on a single carrier frequency. Therefore, a TDD base station can utilise “channel reciprocity” (after performing the required calibrations) to accurately infer the DL channel by measuring the uplink channel. Thus, it is normally sufficient to feedback some channel quality information (CQI) observed at a TDD UE based on SINR measurement. In LTE FDD mode, a base station performs transmission and reception on two distinguishable carrier frequencies. “Channel reciprocity” may thus no longer be used and thus each FDD UE is required to measure and feedback information about the DL channel in addition to CQI to enable closed loop transmit precoding.

In general, the performance of the closed loop transmit precoding improves as the accuracy of the feedback downlink channel information increases and when the information is received in timely manner. In other words, the duration between the time when the channel is measured and the time when precoding based on the measurement is applied should be small.

In codebook based implicit feedback schemes, the UE and the eNB generally use a common or shared codebook, which consists of multiple sub-codebooks—one for each supported rank. A UE would ideally search over the shared codebook on all possible ranks and associated precoder matrices for each rank, that best represents the channel based upon the reference signal measurement, or that gives the maximum received signal. Then the UE then feeds back the selected rank as a rank indicator (RI) and the index of the selected precoder codeword within the sub-codebook of the selected rank referred as a precoder matrix index (PMI). At the eNB, the RI and the PMI are used to select the precoder matrix from the shared codebook. The eNB will then use CQI and the obtained PMI, possibly along with other feedback information (for example HARQ) and other measurements to decide the transmit precoding to use for the incoming DL data transmission.

In LTE TM4, TM5 and TM6, the eNB is restricted to use one of the codewords from the common or shared codebook for transmit precoding. The codeword that is used for precoding is signalled using DL control signalling to help UE demodulate the data signals. In LTE TM8, TM9 and TM10, the eNB is not restricted to use one of the codewords from the common or shared codebook and can use any precoding. A dedicated data demodulation reference signal (DMRS) which is also precoded using the same precoding codeword is transmitted to help the UE demodulate the data signals.

When the number of codewords in the codebook is increased, more feedback bits are required to convey the PMI and more bandwidth is required in the UL to feed back the information. Also the feedback must be reported in timely manner (within the coherence time of the fading channel), otherwise the feedback information will get out-dated.

FIG. 4 illustrates an example of a two-stage codebook for rank L. The codebook has two sub-codebooks, namely a 1st stage codebook and a 2nd stage codebook. The PMI is composed of two sub-PMIs, where the first sub-PMI is generated from the first stage codeword from the first stage codebook and the second sub-PMI is generated from the second stage codeword from the second stage codebook. The final codeword is the product of the first stage codeword and the second stage codeword.

The first sub-PMI(s) may be used to represent and track the long term wideband behaviour of the channel such as channel correlation properties, and the second sub-PMI(s) may be used to represent and track the instantaneous and/or the frequency selective properties of the effective channel that will be formed when the first codeword is used. In general, the dimension of the effective channel is much smaller than the actual physical channel, and so it is easier to track it with higher resolution.

Each codeword W1^{(k)} in the first stage codebook which is a DFT-based codebook represent a set of three beams bₐ₁₍ₖ₎, bₐ₂₍ₖ₎ and bₐ₃₍ₖ₎. Each second codeword W2⁽ⁿ⁾ in the second stage codebook represents, for each layer, a selection of one of the beams and a phase correction term dₙ from a constrained set of alphabet.

The codebook is suitable where the transmit antenna ports are correlated and arranged in uniform linear array. A very similar idea is used in LTE-A two-stage codebook design which is more suitable for the case where two sets of correlated antennas are arranged in uniform linear array. An example of such antenna arrangement is uniform linear array of cross polarised antennas where antennas of one polarization represent one set of correlated antennas. It is also suitable for eNB antenna arrangements where two widely spaced antenna radomes are used where each radome has closely spaced ULAs.

One of the codebook design that has been adopted in 3GPP LTE-A is the two-stage codebook design. Presently TM8, TM9 and TM10 can use two-stage codebooks for 4 antenna port and 8 antenna port transmissions. The codebook can be represented mathematically as follows.

First stage codebook C₁ is defined as follows:

C₁={W1^{(k)};k=0,1, . . . N₁−1}

where each codeword W1^{(k)} is expressed as

$$W {1}^{( k )} = [ \begin{matrix}{X}^{( k )} & 0 \\ 0 & {X}^{( k )}\end{matrix} ]$$

$${X}^{( k )} = [ {b}_{{a}_{1} ( k )} {b}_{{a}_{2} ( k )} … {b}_{{a}_{A} ( k )} ]$$

elements of bₙ is given by,

bₙ[m]=\tilde{b}ₙ[m];n=0,1, . . . ,31;m=0,1, . . . ,(n_{T}/2⁻¹)

\tilde{b}ₙ[m]=e^{j2πnm/32};n,m=0,1, . . . ,31

vectors \tilde{b}ₙ
are columns of DFT matrix and they create a grid of beams in the beam space.

Thus W1^{(k)} is an n_{T}×2 A shaped matrix. It represents beamforming by two sets of n_{T}/2 correlated antennas to form A grid of beams each corresponding to the beamforming vectors bₐ_{ᵢ}₍ₖ₎, i=1, 2, . . . , A. This is an example of a DFT based codebook.

For example, in an 8Tx codebook, the beams formed by codeword W1^{(k)} can be adjacent

r=1,2:N₁=16,A=4,aᵢ(k)=(2k+i−1)mod 32,

r=3,4:N₁=4,A=6,aᵢ(k)=(4k+i−1)mod 32

For a 4Tx codebook, the beams formed by codeword W1^{(k)} are wide spaced

r=1,2:N₁=16,A=4,aᵢ(k)=(k+8(i−1))mod 32

The second stage codebook C₂ is defined as follows

C₂={W2⁽ⁿ⁾;n=0,1, . . . N₂−1}

Where each column c of W2⁽ⁿ⁾, W2_{c}⁽ⁿ⁾ corresponds to the precoding vector applied to the cth layer. It has the following structure

$$W {2}_{c}^{( n )} = [ \begin{matrix}{e}_{i} \\ α {e}_{i}\end{matrix} ] , i = 1 , 2 , … , A , α ∈ Q$$

where α is from a constraint alphabet set Q and eᵢ represents a vector with all zero element except for the ith element which is a one. Thus for each layer, W2⁽ⁿ⁾ selects one beam direction from the beam directions in W1^{(k)} and coherently combines the beams from n_{T}/2 each set of transmit antennas.

The final precoding matrix can be expressed as,

W=W1^{(k)}×W2⁽ⁿ⁾

where W1^{(k)}∈C₁ is the first precoding matrix corresponding to the first PMI, and
W2⁽ⁿ⁾∈C₂ is the second precoding matrix corresponding to the second PMI.

CSI may be reported by the UE to the base station using UL channels. In LTE/LTE-A, the PUCCH (Physical Uplink Control Channel) or PUSCH (Physical Uplink Shared Channel) can be used by a UE for reporting the CSI feedback. The amount of feedback information being transmitted on PUCCH is quite restricted. So this channel is used for periodic reporting of limited CSI information. A UE can be configured in one of many periodic reporting modes depending on the CSI information that is required at the eNB. Further in each reporting mode, different report types can be configured to be sent at distinct period and offset. Where PUSCH is designed to support detailed CSI information that is multiplexed with the UL data. Depending on the CSI requirements (for instance just before scheduling a UE), eNB can configure a UE to report detailed CSI information at a specific time using the PUSCH channel. The configured aperiodic reporting mode will decide which information is required to be reported.

Two-stage codebook supports flexible PMI reporting. FIG. 3 illustrates an example on reporting configuration where the first and the second sub-PMIs are reported at different frequency and offset. First sub-PMI which is expected to change slowly can be reported at a lower frequency than the second sub-PMI which is expected to change more frequently.

### SUMMARY

The following analysis is given by the inventor of the present application. A problem with 1D MIMO systems of the prior art is that they are generally inefficient, particularly when UEs are spread both horizontally and vertically (i.e. upwards in a building).

Two-dimensional antenna arrays enable the use of spatial transmit processing techniques such as adaptation of vertical beam pattern and/or tilt, vertical sectorization and 3D beamforming. It has been shown that these technologies can considerably further improve the performance of cellular systems.

3D beamforming is a technique where closed loop transmit precoding is used at the base station to adapt or adjust base station transmit beam(s) in both horizontal and vertical planes to improve the received signal level at a particular UE while reducing the interference to other users. FD-MIMO technology refers to using large number of antennas to form narrower vertical/horizontal beams to further improve performance.

Both 3D beamforming and FD-MIMO make use of the reported or estimated channel state information at the transmitter to optimally precode the transmission from the transmit antennas.

Advanced cellular systems such as 3GPP LTE/LTE-A with specific design being recollected above, provide framework to support closed loop transmit precoding. However, they were designed taking into account conventional horizontal antenna arrangements at base station, and cannot be used to realise two-dimensional antenna arrays arrangement supporting 3D-BF or FD-MIMO.

For example, when a large amount of antennas are used, as is generally the case for 3D-BF or FD-MIMO, there is generally not sufficient UL transmission bandwidth available for feedback. Furthermore, the large number of antennas places a heavy processing burden on UEs in relation to PMI feedback.

It is to be clearly understood that mere reference herein to previous or existing devices, apparatus, products, systems, methods, practices, publications or to any other information, or to any problems or issues, does not constitute an acknowledgement or admission that any of those things, whether individually or in any combination, formed part of the common general knowledge of those skilled in the field, or that they are admissible prior art.

The present invention is directed to data communication in advanced wireless communication networks, which may at least partially overcome at least one of the abovementioned disadvantages or provide the consumer with a useful or commercial choice.

With the foregoing in view, the present invention in one form, resides broadly in a method of data communication in a wireless communication system, the wireless communication system including a base station comprising a plurality of antennas arranged in an array of at least two dimensions, the method including:

receiving, at a user equipment (UE) and from a set of the plurality of antennas, a plurality of reference signals, wherein the set of antennas includes antennas arranged in two spatial dimensions;
deriving channel estimates based on at least one received reference signal of plurality of reference signals;
selecting at the UE based on the channel estimates, a precoding matrix from at least one configurable precoding codebook by applying an associated configurable precoder function to matrices in the configurable precoding codebook; and
transmitting, from the UE to the base station, the channel information wherein the channel information includes an identifier of the selected precoding matrix.

Embodiments of the present invention enable improved system throughput for 3D-beamforming and FD-MIMO.

The step of selecting the precoding matrix may comprise selecting a first stage matrix from a first stage codebook; and selecting a second stage matrix from a second stage codebook, wherein the associated precoder function includes a beam sub-selection function which produces an output matrix by removing one or more entries of an input matrix; and selecting the first stage matrix includes applying the beam sub-selection function to matrices in the first stage codebook to form the precoding matrix.

The first stage codebook may comprise first and second sub-codebooks.

The channel information may comprise first sub-channel information corresponding to the first stage codebook and second sub-channel information corresponding to the second sub-codebook.

The first sub-channel information may be reported at a first rate and the second sub-channel information at a second rate.

The first sub-channel information may be used to track a long term or wideband channel state in a first spatial dimension, and the second sub-channel information to track the long term or wideband channel state in a second spatial dimension.

The channel information may further comprise third sub-channel information for tracking a short-term or sub-band channel state in a reduced dimension channel. The third sub-channel information may be reported at a higher rate than the first and second sub-channel information.

The method may comprises generating a precorder, wherein generating the precoder comprises forming an intermediate matrix from a selected matrix from the first sub-codebook and a selected matrix from the second sub-codebook; and applying the beam sub-selection function to the intermediate matrix.

The intermediate matrix (W1ᵢₙ) may be formed according to:

W1ᵢₙ=W1_{V}×W1_{H}

where W1_{V} is the selected matrix from one sub-codebook and W1_{H} is the selected matrix from the other sub-codebook, and x is one of a Kronecker product and a Khatri-Rao product.

The beam sub-selection function, f, may be formed according to:

W1ₒᵤₜ=f(W1ᵢₙ)=W1ᵢₙ*E

where, * is matrix multiplication, W1ᵢₙ is the intermediate matrix from the first stage codebook, W1ₒᵤₜ is a matrix defining the first stage codebook precoder, and E is a column selection matrix.

The precoder may comprise a precoding matrix, W, and may be formed according to:

W=f(W1ᵢₙ)*W2

where, * is matrix multiplication, W1ᵢₙ is the intermediate matrix from the first stage codebook, W2 is a matrix selected from the second stage codebook and f is the beam sub-selection function.

The first and second sub-codebooks may be Discrete Fourier Transform (DFT) based codebooks.

The precoder (W) may determined according to

W=(W1_{V}^{(m)}*W1_{H}^{(k)}×E×W2⁽ⁿ⁾

where W1_{V}^{(m)}∈C_{1V}
is a first stage codeword matrix corresponding to a first dimension, and C_{1V} is a first sub-codebook of a first stage codebook; W1_{H}^{(k)}∈C_{1H} is a first stage codeword matrix corresponding to a second dimension, and C_{1H} is a second sub-codebook of a first stage codebook; W2⁽ⁿ⁾∈C₂ is a second stage codeword matrix and C₂ is a second stage codebook; and * represents the Khatri-Rao product.

The set of antennas may comprise the plurality of antennas, i.e. all of the plurality of antennas.

Alternatively, the set of antennas may comprise a subset of the plurality of antennas. In such case, the UE may be informed of the subset of antennas.

According to certain embodiments, the method further comprises:

grouping the plurality of antennas into a plurality of correlated sets; and
selecting the subset of antennas from one row and one column from each of the plurality of correlated sets.

The plurality of correlated sets may include a first set having a first polarization, and a second set having a second polarization.

The subset of antennas may be equally spaced along the one column and the one row.

In another form, the present invention resides broadly in a base station comprising:

a plurality of antennas arranged in an array of at least two dimensions;
a processor coupled to the plurality of antennas; and
a memory coupled to the processor, the memory including instruction code executable by the processor for:
transmitting, from a set of the plurality of antennas, a plurality of reference signals, wherein the set of antennas includes antennas arranged in two spatial dimensions;
receiving, from a UE, channel information relating to the set of antennas, wherein the channel information was generated at least in part according to a reference signal of the plurality of reference signals;
generating a precoder using at least the channel information, at least one precoding codebook, and a precoder function; and
transmitting data to the first UE using the precoder.

In yet another form, the present invention resides broadly in a user equipment (UE) comprising:

at least one antenna;
a processor coupled to the antenna; and
a memory coupled to the processor, the memory including instruction code executable by the processor for:
receiving, at the at least one antenna and from a set of antennas, a plurality of reference signals, wherein the set of antennas includes antennas arranged in two spatial dimensions;
selecting a precoding matrix from the configurable precoding codebook by applying the associated configurable precoder function to matrices in the configurable precoding codebook;
generating, by the processor, channel information including an identifier of the selected precoder matrix; and
transmitting, from the at least one antenna and to a base station, the channel information.

Advantages of certain embodiments of the present invention include an ability to provide improved system throughput for 3D-beamforming and FD-MIMO techniques with an amount of feedback bits being comparable to a legacy LTE/LTE-A system.

Embodiments of the present invention enable use of computationally and memory efficient algorithms for CSI calculation.

Further, by using a configurable design in certain embodiments, the same shared codebook/sub-codebook can be used to support different eNB antenna port configurations, which is memory efficient.

Embodiments of the present invention allow flexible performance-feedback trade-offs, and can thus can be configured to be used for CSI reporting in UL channels with different capacity.

Embodiments of the present invention are backward compatible and can be configured to be used with conventional beamforming techniques and so can support eNBs with conventional antennas.

Further, embodiments of the present invention enable the re-use of codebooks designed according to the conventional double-stage codebook principle, which simplifies such implementation.

Embodiments of the present invention provide a method for reporting PMI which comprises using two independent sub-codebooks as reference to report two sub-PMIs at possibly different rate/offset, each one used to track the long term and/or wideband channel state along one of the two spatial dimensions and using another sub-codebook to report the third sub-PMI at possibly higher rate to enable tracking the short-term and/or sub-band effective reduced dimensional channel. This method can provide improved system throughput for 3D-BF and FD-MIMO techniques while supporting computationally and memory efficient algorithms for CSI computation.

Embodiments of the present invention provide a method to carry out CSI computation where channel characteristics along each dimension are used to search for the optimum codeword in a corresponding sub-codebook configured for that dimension.

Embodiments of the present invention provide a codebook to support the above methods. The codebook design allows the same shared codebook/sub-codebook to be configured to support different eNB antenna port configurations, to be configured to be used with different UL channel requirements, and also allows re-using previously designed codebooks. Furthermore, a method to achieve configurable trade-off between performance and the size of the third sub-codebook by beam sub-sampling is shown.

Embodiments of the present invention provide a method to reduce the required number of reference signals for CSI estimation, by using spatial sampling and by characterising the correlation of the transmit antenna ports arranged in a 2D array as a ‘Kronecker’ product of the correlation of the transmit antenna ports along each dimension is also presented.

Any of the features described herein can be combined in any combination with any one or more of the other features described herein within the scope of the invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

### BRIEF DESCRIPTION OF DRAWINGS

FIG. 1 schematically illustrates a simplified 2×3 SU-MIMO system;

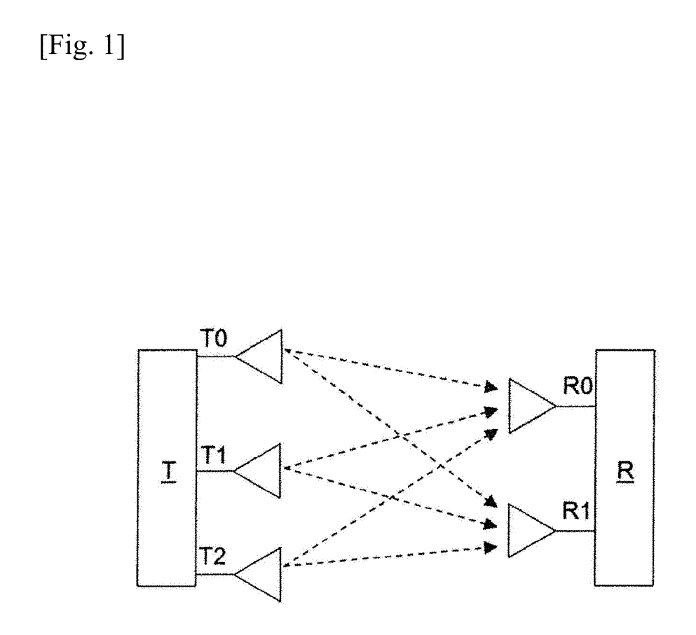

FIG. 2 is a conceptual diagram of a more generalized SU-MIMO system;

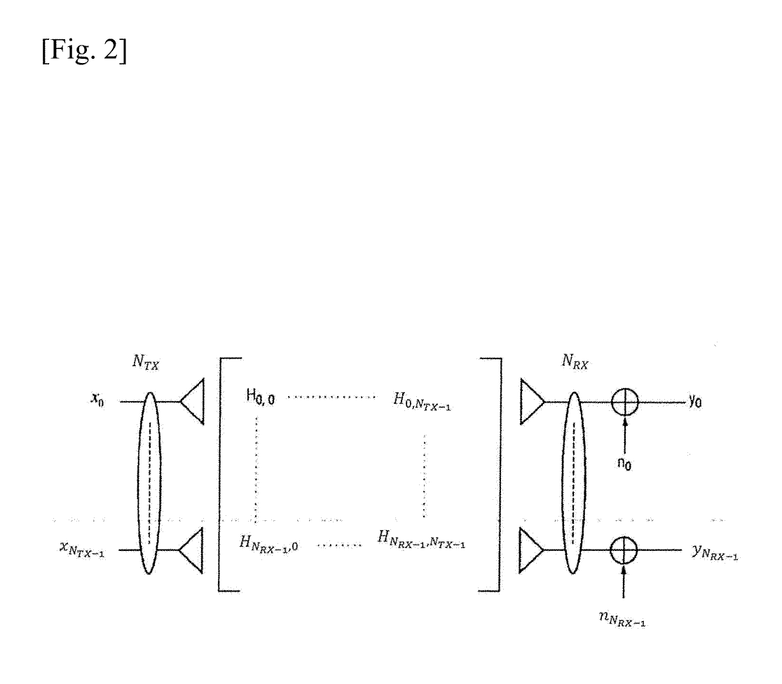

FIG. 3 illustrates 2D beamforming generally;

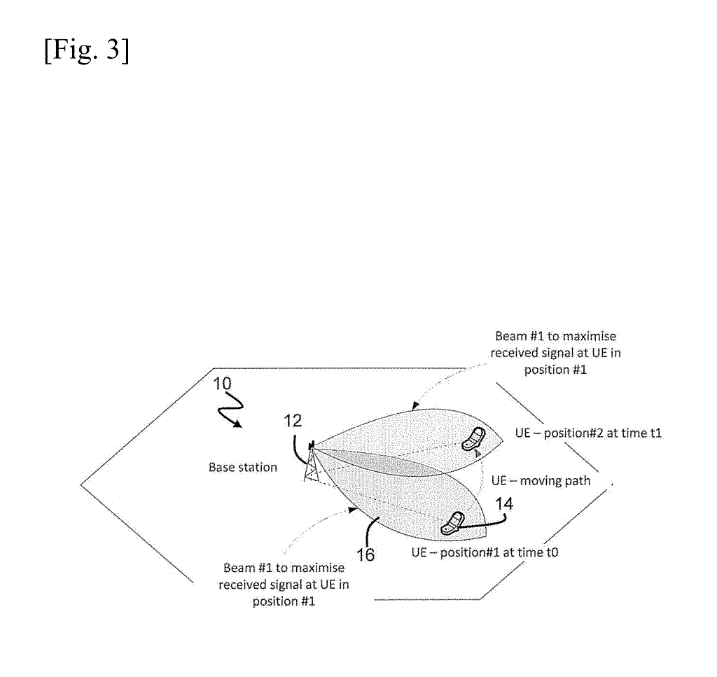

FIG. 4 illustrates 3GPP Rel'10 LTE-A two-stage codebook precoding;

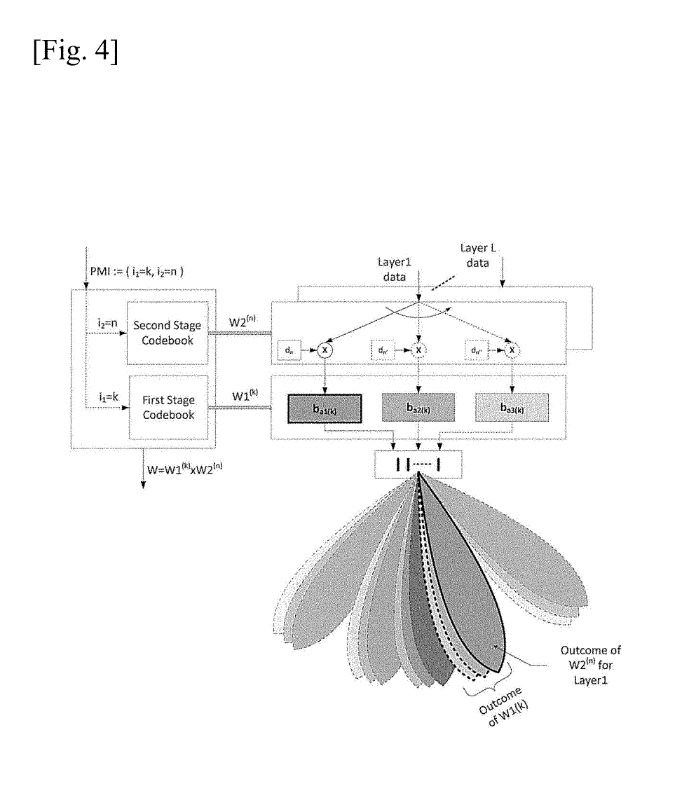

FIG. 5 illustrates 3GPP Rel'10 LTE-A reporting for a 2 stage codebook;

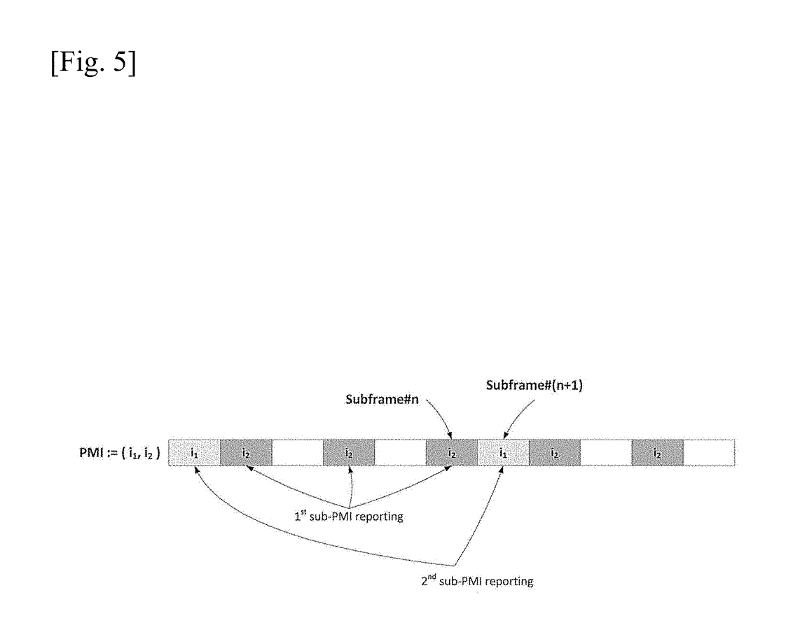

FIG. 6 illustrates an advanced wireless communication system with 3D beam forming, according to an embodiment of the present invention;

FIG. 7 illustrates a block diagram of a base station and a UE of the system of FIG. 6, according to an embodiment of the present invention;

FIG. 8 illustrates examples of reference antenna port selection for use with 8 reference signals, according to an embodiment of the present invention;

FIGS. 9a and 9b illustrate methods of computing channel information with a single codebook, according to an embodiment of the present invention;

FIGS. 10a and 10b illustrate methods of computing channel information with two codebooks, according to embodiments of the present invention;

FIG. 11 illustrates processing of a 3D beamforming codebook, according to an embodiment of the present invention;

FIG. 12a illustrates example DFT codebooks as stage 1 codebooks for both dimensions, according to embodiments of the present invention;

FIG. 12b illustrates example DFT codebooks as stage 1 codebooks for both dimensions, according to embodiments of the present invention;

FIG. 13 illustrates beam sub-sampling patterns, according to an embodiment of the present invention; and

FIG. 14 illustrates PMI reporting for a 3D beamforming codebook; according to an embodiment of the present invention.

### DESCRIPTION OF EMBODIMENTS

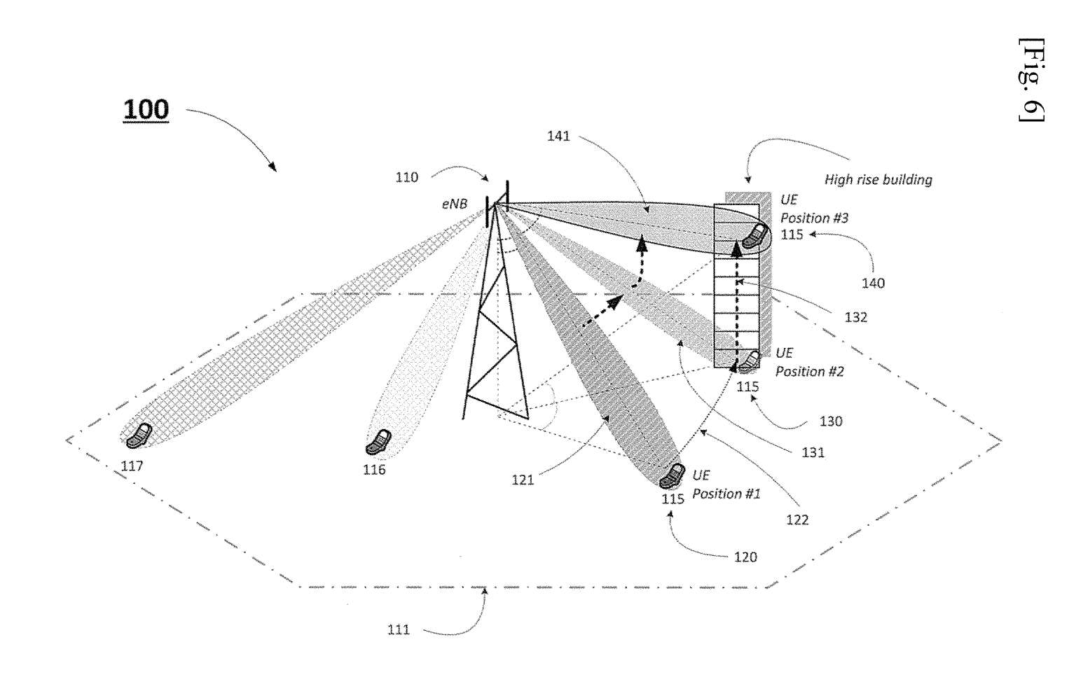

FIG. 6 is a schematic diagram illustrating an advanced wireless communication system 100, according to an embodiment of the present invention. The system 100 includes Three Dimension Beam forming (3D-BF) capability.

The advanced wireless communication system 100 comprises at least one access node comprising a three-dimensional beam forming (3D-BF) capable base station 110, and a plurality of user equipments (UEs) 115, 116, 117. In particular, the access node 110 is equipped with two-dimensional (2D) multiple-input and multiple-output (MIMO) antenna array. Among the plurality of UEs 115-117, there may be one or more 3D-BF UEs, such as 3D-BF UE 115, which is capable in supporting and utilising 3D-BF features and services provided by the base station 110.

Due to mobility, the 3D-BF UE 115 may be displaced horizontally 122, for example by changing its position from a first position 120 to a second position 130. The 3D-BF UE 115 may further be displaced vertically 132, for example by moving up in a tall building and thus changing its position from the second position 130 to a third position 140.

Embodiments of the present invention enable the base station 110 to dynamically steer or adapt a transmission (TX) beam horizontally (for example from a first beam 121 to a second beam 131) and vertically (for example from the second beam 131 to a third beam 141) in order to improve a received signal power of the UE 115.

Furthermore, embodiments of the present invention enable increasing a received signal power of the UE 115, and minimising or even eliminating interference to other UE(s) within the same coverage by creating a narrow TX beam to focus on the UE 115.

The two-stage codebook design used in 3GPP LTE/LTE-A uses a DFT based codebook for the first PMI to form multiple beams. However the 3GPP LTE/LTE-A DFT codebook can capture the information about the beam directions in only one dimension, i.e. for example the horizontal dimension. To support 3D beamforming and FD-MIMO, the codebook needs to be redesigned as information about beam directions in both dimensions (i.e. horizontal and vertical) is required.

According to certain embodiments, the codebook design ensures that sufficiently channel state information can be captured and feedback using only the minimum amount of feedback bits.

According to certain embodiments, reporting can be flexibly configured to trade-off performance and feedback channel capacity. This allows the codebook to be used with UL channels that support different feedback capacity such as PUCCH and PUSCH in 3GPP LTE/LTE-A systems.

Since the codebook is used at both transmit side and receiver side, certain embodiments enable the codebook to be stored using small amount of memory, and that one codebook can be configured to be used for different scenarios, for example with different antenna arrangements, with other transmission modes such as MU-MIMO, CoMP.

For instance, it should also be possible to configure this codebook to be used with eNBs that employ conventional antenna systems and it should also be possible to use this codebook to support conventional UEs that can report feedback using the existing Rel-12 codebook.

As such, embodiments of the present invention provide a codebook design that takes into account the above constraints/considerations to efficiently support 3D beamforming and FD-MIMO.

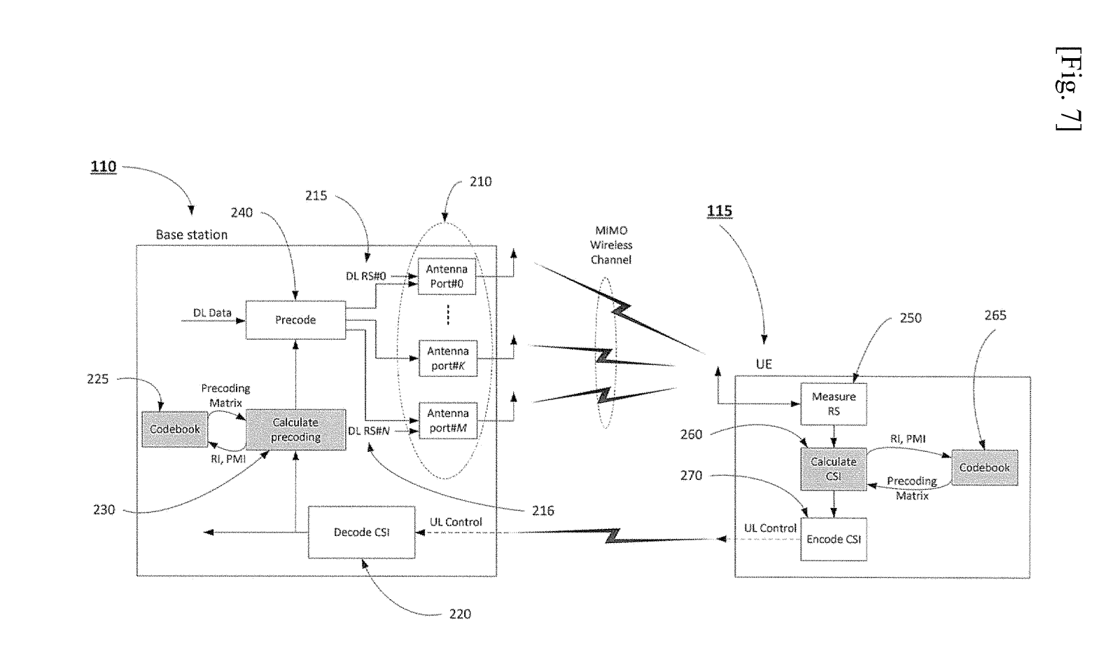

FIG. 7 illustrates a block diagram of the base station 110 and the UE 115, according to an embodiment of the present invention.

The base station 110 includes a plurality of antenna ports 210 from which a plurality of DL reference signals 215, 216 are transmitted. The DL reference signals 215, 216 may be transmitted from a sub-set of the transmit antenna ports 210, in order to reduce complexity at the UE, in particular in relation to calculation of channel state information (CSI). The sub-set of the transmit antenna ports 210 is referred to as the reference antenna ports.

The DL reference signals 215, 216 are received by the UE 115 after passing through the MIMO wireless channel. The DL reference signals 215, 216 may be received by multiple antennas at the UE 115. The received reference signals are used by a ‘measure RS’ function 250 to estimate the channel for each reference branch of the MIMO wireless channel. Each reference branch corresponds to a link between a reference antenna port and an antenna at the UE 115. To perform the CSI computation, the UE 115 uses knowledge of the transmit antenna port configurations, e.g. how many transmit antenna ports, how they are arranged, their polarizations, and from which transmit antenna ports which reference signals are transmitted.

Based on the estimated channel of the reference branches, CSI in the form of a precoder matrix indicator (PMI), rank indicator (RI) and channel quality indicator (CQI) is calculated by a ‘calculate CSI’ function 260. To calculate the CSI, the ‘calculate CSI’ function 260 uses a codebook 265 which is a common/shared between the base station 110 and the UE 115. The calculation generally involves searching over the codebook 265 and selecting a rank and precoder matrix that provides the highest expected gain, such as received signal power. The rank is indicated by the rank indicator RI and the precoding matrix is indicated by the index of the precoder codeword within the codebook corresponding to the selected rank as the PMI.

The calculated CSI is then encoded by an ‘Encode CSI’ function 270 and fed back to base station using either uplink (UL) control channels or by being multiplexed with data on an UL data channel.

At the base station 110, the UL control information is received, and decoded by a CSI decoding function 220 to obtain the CSI (including the PMI, RI and CQI). Based on the decoded CSI feedback, the precoding is calculated by a ‘calculate precoding’ module 230.

The ‘calculate precoding’ function 230 uses a shared codebook 225 (corresponding to codebook 265) which is a common/shared codebook with participating UEs. Given the RI and the PMI from a UE 115, the codebook 225 is used to obtain the corresponding precoding matrix for that UE. The precoding matrices of the participating UEs are then used along with other information to precoded data by a ‘precode’ function 240. The precoded data is then transmitted from the transmit antenna ports 210.

In one embodiment, the antenna reference ports are fixed and predefined. In this case the UE can perform a CSI computation based on the fixed predefined configuration. In another embodiment, one or more of the configuration values are provided to the UE via signalling, such as higher layer (i.e. RRC) signalling.

According to alternative embodiments, explicit non-codebook based feedback can also be used to feedback the CSI. In such case, instead of each participating UE sending a PMI which is an index into a codebook, the channel characteristics seen by each UE are directly quantized and fed back by each UE together with the RI and CQI. The channel characteristics that are normally quantized are the eigenvalues and corresponding eigenvectors of the normalized transmit correlation matrix or equivalently the singular values and the corresponding right singular vectors of the normalized channel matrix.

Although the present invention is described primarily in terms of codebook based implicit feedback, aspects of the invention can also be applied to explicit non-codebook based feedback.

When there is a large number of transmit antenna ports, such as is generally the case in 3D BF and full dimension (FD)-MIMO, transmitting a reference signal for each transmit antenna port may not be practical. For example, transmitting a large number of reference signals will result in fewer time-frequency resources being available for other data and control signals. As such, any gain obtained from closed loop transmit precoding may be lost due to the cost of reference signal transmission.

As such, according to certain embodiments of the present invention, a subset of the transmit antenna ports (said sub-set being referred to as the reference antenna ports) is selected and the reference signals are transmitted from these reference antenna ports only. In such case, the statistics required for CSI computation are obtained using the reference branches of the MIMO wireless channel only, rather than for all the branches of the MIMO wireless channel.

For the operation of 3D BF and FD-MIMO, it is important that this subset enables an accurate estimation of the channel statistics required for the computation of the CSI. In such case, the correlation/covariance between the transmit antenna ports may be used for CSI computation.

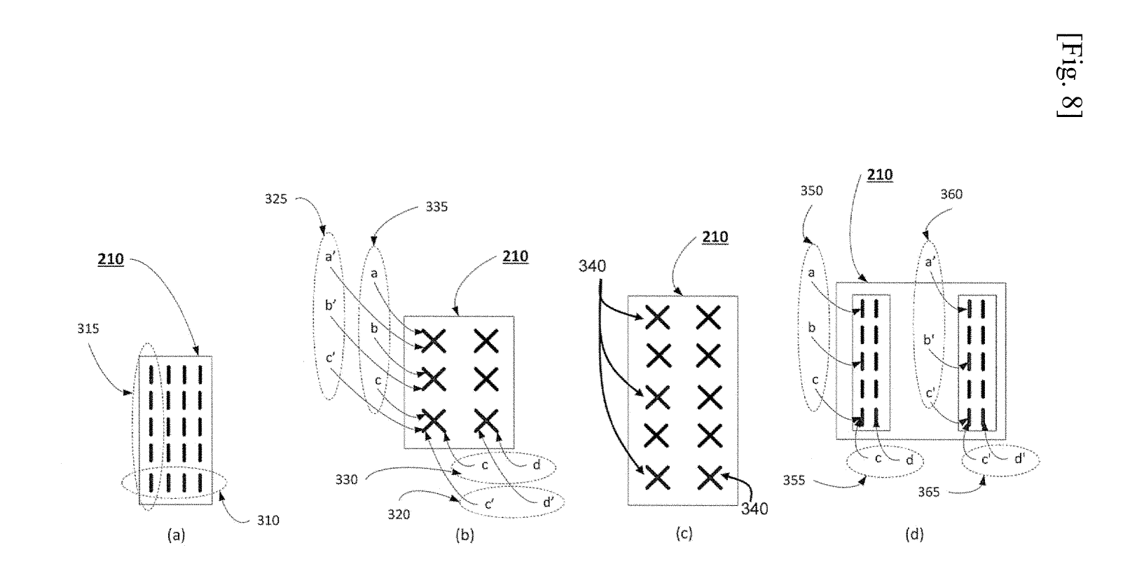

FIG. 8a illustrates an example of reference antenna port selection, according to an embodiment of the present invention. The antenna ports 210 are configured in a co-polarized critically spaced (i.e. each element spaced half wavelength apart) uniform rectangular array (URA) arrangement.

The reference antenna ports comprise antenna ports in one row 310 and one column 315. The channel statistics (for example correlation between the transmit antenna ports) may be estimated at the UE fairly accurately for all the antenna ports 210 by measuring the reference signals from the reference antenna ports.

For example, if R_{V} is the estimated correlation between the reference antenna ports in one column and R_{H} is the estimated correlation between the reference antenna ports in one row, then the correlation between all the transmit antenna ports, R can be computed according to

R=kron(R_{V},R_{H}). (Equation 1)

where kron( ), is the Kronecker product function.

FIG. 8b illustrates a further example of reference antenna port selection, according to an embodiment of the present invention. The antenna ports 210 are configured in a cross-polarized critically spaced URA arrangement.

The reference antenna ports comprise a first set and a second set. The first set of antenna ports comprises antenna ports in one row 320 and one column 325, all having a first polarization. The reference antenna ports of the second set comprises of antenna ports in one row 330 and one column 335, all having a second polarization.

For each correlated set (e.g. polarization), the channel statistics of all the antenna ports in that set is estimated at the UE based on the measurements of the reference signals transmitted from the reference antenna ports in that set. This can be done in a similar manner to that described above in the context of FIG. 8a by evaluating a Kronecker product function. The correlation between the polarizations is measured by averaging the correlation between the corresponding reference antenna ports in each polarization set.

FIG. 8c, illustrates yet a further example of reference antenna port selection, according to an embodiment of the present invention. The antenna ports 210 are configured in a cross-polarized critically spaced URA arrangement. This configuration is similar to the one described with reference to FIG. 8b above. Spatial sampling is, however, used to reduce the number of reference signals further. In particular, each correlated set (polarization) is spatially interpolated in each dimension to generate selected antenna ports 340, before applying similar steps as discussed with reference to FIG. 8b.

FIG. 8d illustrates yet a further example of reference antenna port selection, according to an embodiment of the present invention. The antenna ports 210 are configured in two widely spaced sets of co-polarized critically spaced URA arrangements. This example is similar to the example in FIG. 6c, except that the two correlated sets are formed from placing the two sets of antennas widely than using cross-polarisation.

As discussed above, in order to calculate the PMI, RI and CQI at the UE, a codebook may be searched to find the best codeword matrix that would be optimum based on some criteria.

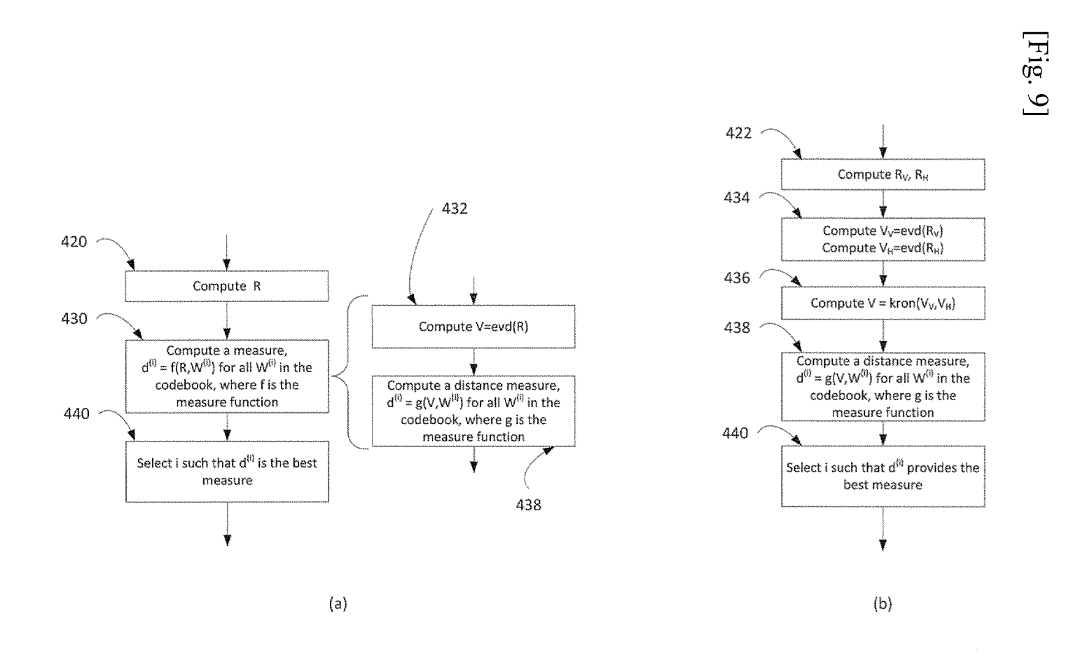

FIG. 9a illustrates a method of computing channel information, according to an embodiment of the present invention.

At step 420, the transmit antenna correlation matrix, R, is computed.

At step 432, the eigenvectors of the transmit correlation matrix, V=evd(R), are computed.

At step 438, a ‘distance’ measure between V and a codeword matrix, W(i), is computed for each codeword matrix in the codebook.

At step 440, the best codeword matrix, W is selected based upon the distance. Channel information, including an indicator of the best codeword matrix, may then be sent to the server.

When the number of antenna ports increases, as in the case of 3D BF and FD-MIMO, the dimensionality of the correlation matrix increases and this leads to the increased complexity of the above search process. Given the fact that it is important to feedback CSI information in a timely manner for adequate system performance, it is important to reduce the computational complexity.

This can be achieved by computing the eigenvectors V as follows:

V=kron(V_{V},V_{H}) (Equation 2)

where V=evd(R), VV=evd(R_{V}) and VH=evd(R_{H}).

FIG. 9b illustrates a method of computing channel information, according to an alternative embodiment of the present invention.

At step 422, the transmit antenna correlation matrices R_{V}, R_{H} are computed along each dimension (e.g. column and row).

At step 434, the eigenvectors V_{V}, V_{H} of the correlation matrices R_{V}, R_{H} are computed.

At step 436, the eigenvectors V are determined according to V=kron(V_{V}, V_{H})

At step 438, a ‘distance’ measure between V and a codeword matrix, W(i), is determined for each codeword matrix in the codebook.

At step 440 the best codeword matrix, W, is selected according to the distance measure. As discussed above, channel information, including an indicator of the best codeword matrix, may then be sent to the server.

The method of FIG. 9b can have significantly reduced computational complexity when compared with the method of FIG. 9a.

As discussed above, explicit non-codebook based feedback may be used in relation to the present invention. In such case, instead of quantizing and feeding back the eigenvectors V and their corresponding eigenvalues, the eigenvectors V_{V} and V_{H} and their corresponding eigenvalues may be quantized and fed back.

Computation complexity and memory requirements may be further reduced by designing a codebook as two sub-codebooks, where one sub-codebook has a set of W_{V}^{(m)} matrices and another sub-codebook has a set of W_{H}^{(k)} matrices. The codebook elements may all be set to kron(W_{V}^{(m)}, W_{H}^{(k)}) resulting from the combination of W_{V}^{(m)} and W_{H}^{(k)}. This provides an opportunity to reduce the complexity of the searching by carrying out two independent searches.

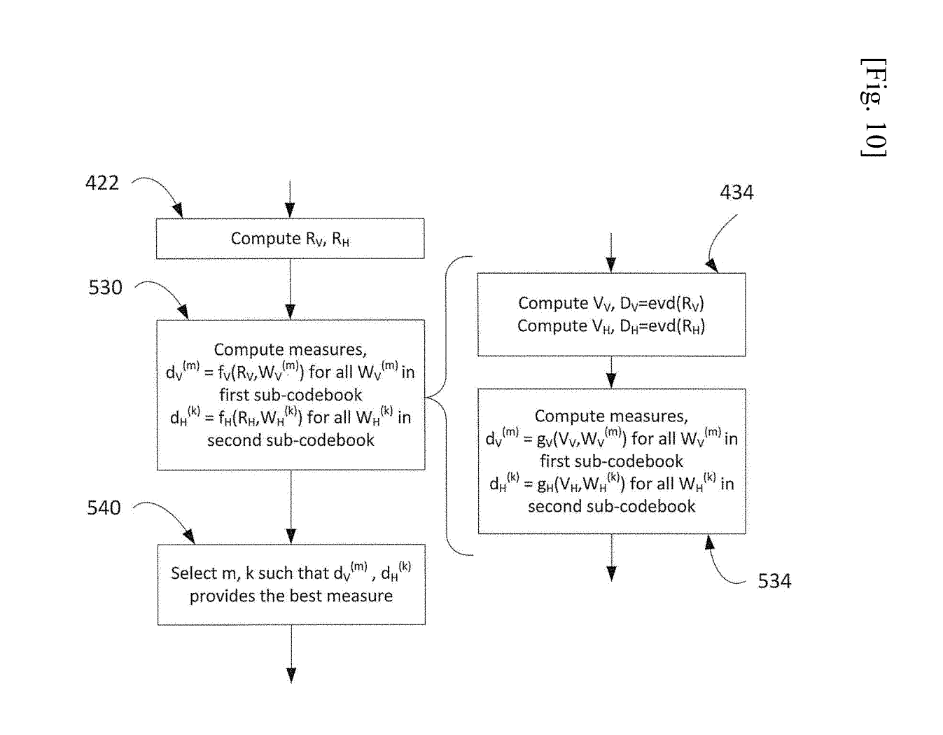

FIG. 10 illustrates a method of computing channel information, according to an alternative embodiment of the present invention.

At step 422, the transmit antenna correlation matrices R_{V}, R_{H} are computed along each dimension (e.g. column and row).

At step 434, the eigenvectors V_{V}, V_{H} of the correlation matrices, R_{V}, R_{H} are determined.

At step 534 a ‘distance’ measure between V_{V} and a codeword matrix W_{V}^{(m)} is calculated for each codeword matrix in a sub-codebook. Furthermore, a ‘distance’ measure between V_{H} and a codeword matrix W_{H}^{(k)} is calculated for each codeword matrix in a sub-codebook.

At step 540, the best codeword matrix W is generated according to the distance measures. In particular, W is generated according to kron(W_{V}, W_{H}), where W_{V} and W_{H} as the codeword matrices that provides the best distance measures.

The method of FIG. 10 not only enables a reduction in computational complexity, but also simplifies the codebook design. Here the codebook comprises sub-codebooks in each dimension, and in certain embodiments may comprise re-using already existing codebooks for 2D beamforming as the sub-codebooks. This also advantages in terms of the storage required at the UE and base station to store the codebooks is reduced.

For example, the transmit antenna port configurations may be represented as (N_{V}, N_{H}) where N_{V} is the number of antenna ports in one column and N_{H} is the number of antenna ports in one row. For values N_{V}=1, 2, 4 and N_{H}=1, 2, 4 there are thus 8 possible multiple antenna port combinations.

Instead of designing and using 8 codebooks for the 8 possible combinations, embodiments of the present invention use 4 codebooks, i.e. 2 codebook for N_{V} and 2 codebook for N_{H}. In other words, it is possible to combine codebooks of each dimension depending on the number of correlated antennas in each dimension. Furthermore, certain embodiments of the invention provide a further reduction in number of codebooks by configuring the same codebook for both dimensions.

According to certain embodiments, the PMI is reported in parts, i.e. a first sub-PMI is reported to indicate the best codeword within the first sub-codebook, and a second sub-PMI is reported to indicate the best codeword within the next sub-codebook. The first and second sub-PMIs may be sent at different times. This in turn also allows flexibility in transmitting the references from the reference antenna ports in each dimension on different sub-frames.

According to certain embodiments, the CSI feedback is split such that one part captures the long term and/or wideband channel property, and in the process reduce the channel dimensions, while the other part captures the short term and/or the sub-band properties of the reduced dimensional channel.

In such case, the codebook comprises three sub-codebooks. Two sub-codebooks are used to track the long term and/or wideband channel properties in a similar as discussed above, i.e. one sub-codebook for each dimension. The third sub-codebook is used to track the short term and/or sub-band characteristics of the reduced dimensional channel.

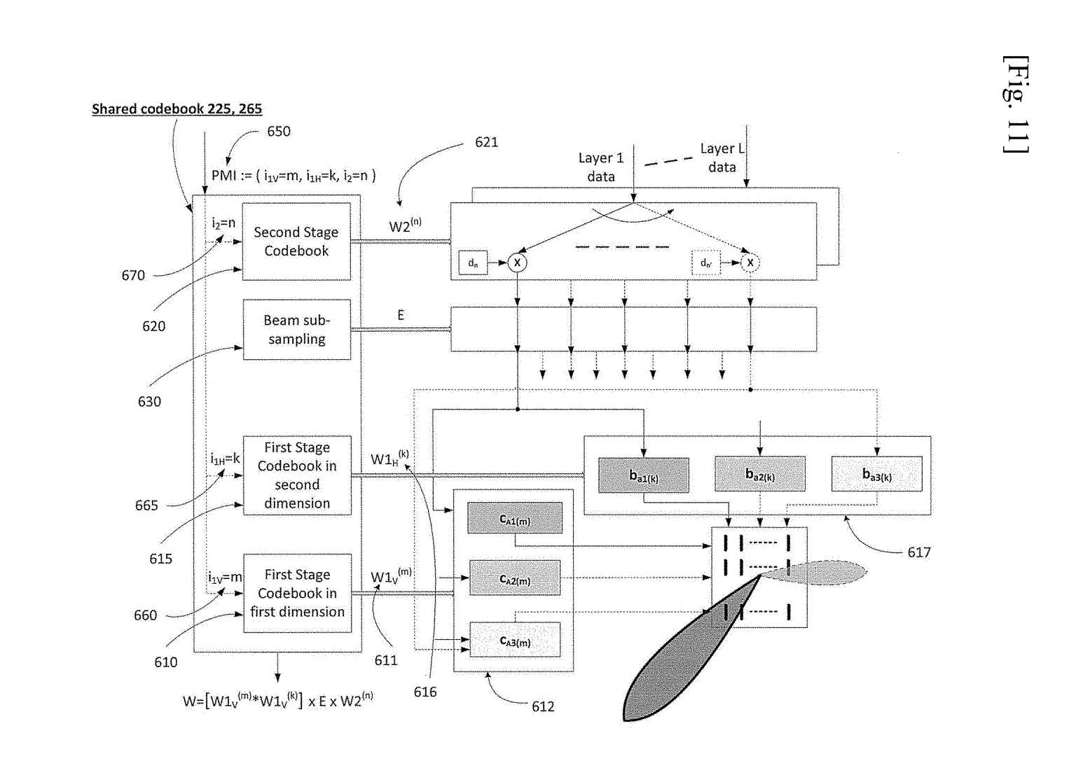

FIG. 11 illustrates processing of a 3D beamforming codebook, according to an embodiment of the present invention. The codebook 225, 265 is shown for rank L. Similar sub-codebooks (with different parameters, different configuration) are used for different ranks, and in some cases the same sub-codebook is used for different ranks.

The shared codebook 225, 265 comprises three sub-codebooks, namely a first stage codebook in a first dimension 610, a first stage codebook in a second dimension 615, and a second stage codebook 620. Optionally, the shared codebook 225, 265 includes a beam sub-sampling function 630.

A PMI 650 comprises three sub-PMIs. The first sub-PMI, i₁ᵥ 660, is used to generate the first stage codeword matrix in one dimension, W1_{V}^{(m)} 611, from the first stage codebook configured for this dimension 610. The second sub-PMI, i_{1H} 665, is used to generate the first stage codeword matrix in the other dimension, W1_{H}^{(k)} 616, from the first stage codebook configured for this other dimension 615. The third sub-PMI, i₂ 670, is used to generate the second stage codeword matrix, W2⁽ⁿ⁾ 621, from the second stage codebook 620.

The first two sub-PMIs 660, 665 are together used to track the wideband and/or the long term behaviour of the channel in the first and second dimensions. The third sub-PMI 670 is used to represent/track the instantaneous and/or the frequency selective properties of the effective channel.

The columns of the codeword matrix W1_{V}^{(m)} in the first stage codebook for the first dimension 610 represent a set of beams bₐ₁₍ₘ₎, bₐ₂₍ₘ₎ and bₐ₃₍ₘ₎ in that dimension, the columns of each codeword W1_{H}^{(k)} in the first stage codebook for the second dimension 615 represent a set of beams c_{A1(k)}, c_{A2(k)} and c_{A3(k)} in the other dimension. As discussed above, the Kronecker product of these two codeword matrices represent a 3×3 grid of 9 beams in the 3D space.

In one embodiment, when the optional beam sub-sampling 630 is not used, the second stage codeword matrix W2⁽ⁿ⁾ in the second stage codebook 620 represents, for each layer, the selection of one of the beams in the grid of 9 (=3×3) beams and a co-phasing term dₙ from a constrained set of alphabet.

Thus the final precoding matrix represented by a PMI, i_{1V}=m, i_{1H}=k, i₂=n can be represented as,

W=kron(W1_{V}^{(m)},W1_{H}^{(k)})×W2⁽ⁿ⁾ (Equation 3)

where kron( ) is the Kronecker product function.

In the above example, the number of codewords in the second stage codebook 620 required to cover the selection and co-phasing of the 9 beams could turn out to be numerous. This could lead to a higher requirement for the capacity of the UL channel for feeding back the third sub-PMI 670.

According to certain embodiments, the number of codewords in the second stage codebook 620 is reduced to consider fewer beams in the codewords in one or both of the first stage codebooks 610, 615.

The beam sub-sampling function, 630 can be used to reduce the dimension of the effective channel formed by applying the effective codeword represented by the first two sub-PMIs 660, 665. The beam sub-sampling function is configured semi-statically or is a predefined function. Further aspects of beam sub-sampling are described with respect to a DFT codebook used as the first stage codebooks.

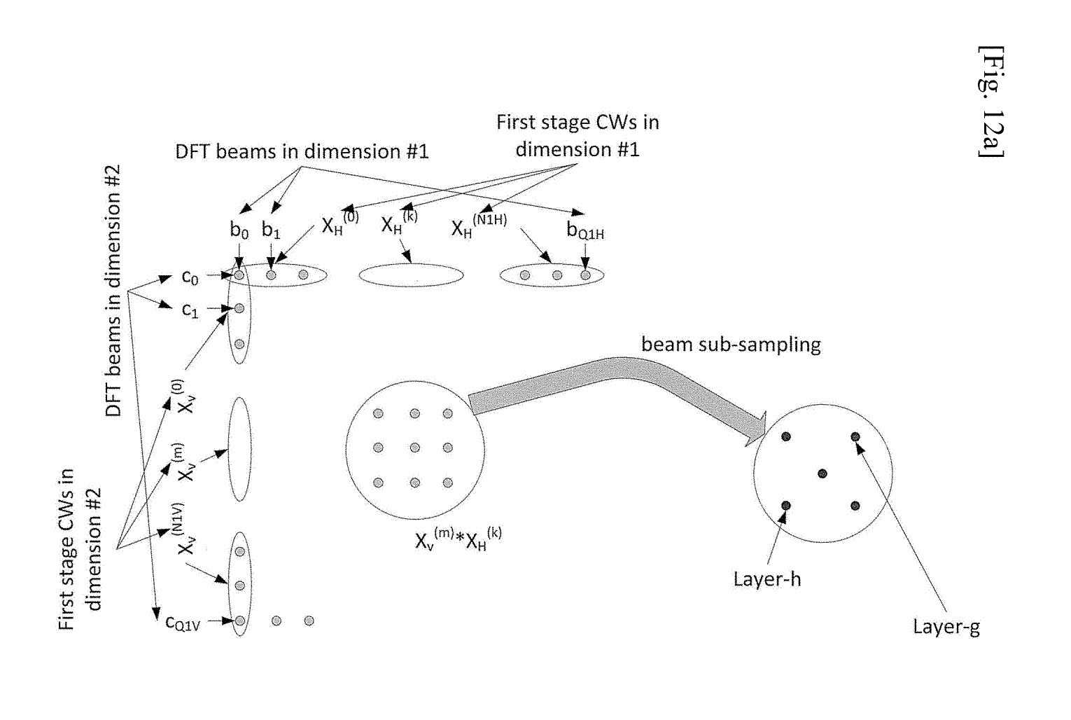

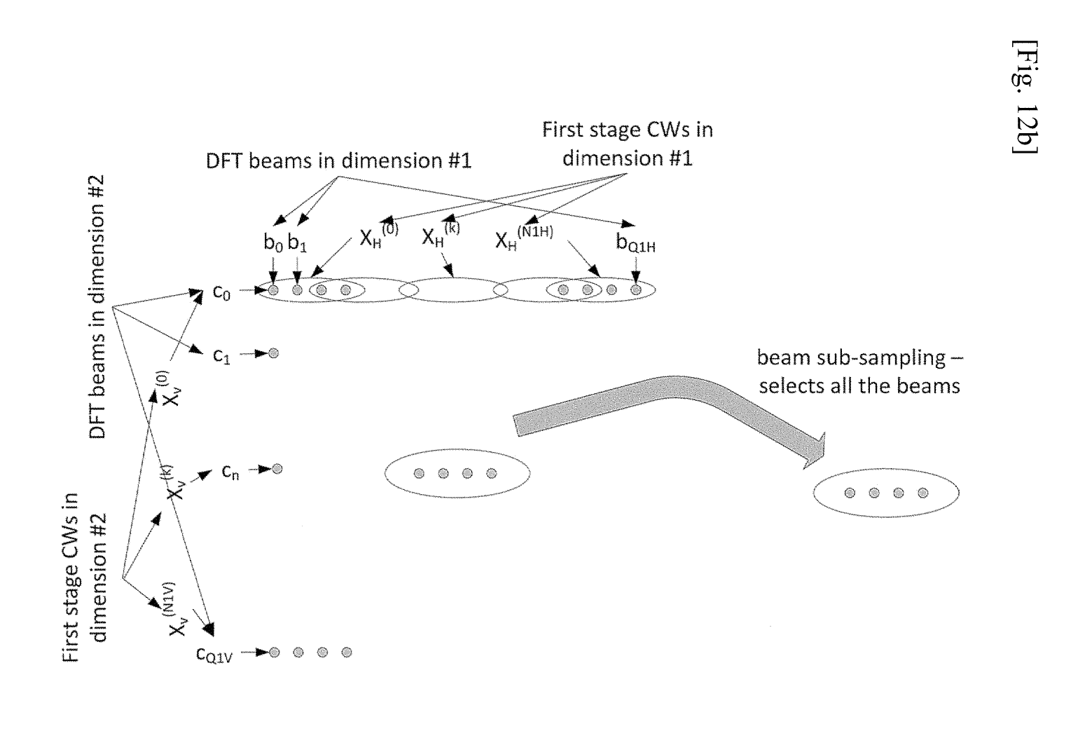

A codebook using the above design is further described with reference to FIG. 12a. A DFT codebook is used as the first stage codebook for both dimensions. Each codeword X_{H}^{(k)} in the first dimension consists of adjacent 3 beams in that dimensions. Each codeword X_{V}^{(m)} in the second dimension also consists of adjacent 3 beams in that dimensions. Then beam sub-sampling function picks 5 beams from the 3×3 grid of beams so that the selected beams still cover the beam space but with lower resolution. Each second codeword W2⁽ⁿ⁾ in the second stage codebook represents, for each layer, a selection of one of the 5 beams and a phase correction term dₙ from a constrained set of alphabet.

In general, the number of beams in the first stage codewords in a dimension, the position of these beams in the DFT grid of beams, and the beam sub-sampling functions can be configured semi-statically or according to a fixed optimized pattern. Another example of a codebook is shown in FIG. 12b. In this case, the first stage codeword in the first dimension consists of 4 adjacent beams and the first stage codeword in the second dimension consist of just one beam. In this case, the Kronecker product of the first stage codewords represent a 1×4 grid of 4 beams. In this case, the beam sub-sampling function selects all the beams in the grid of beams. It is also envisioned that the first stage codewords in a dimension consists of 4 beams that are non-adjacent.

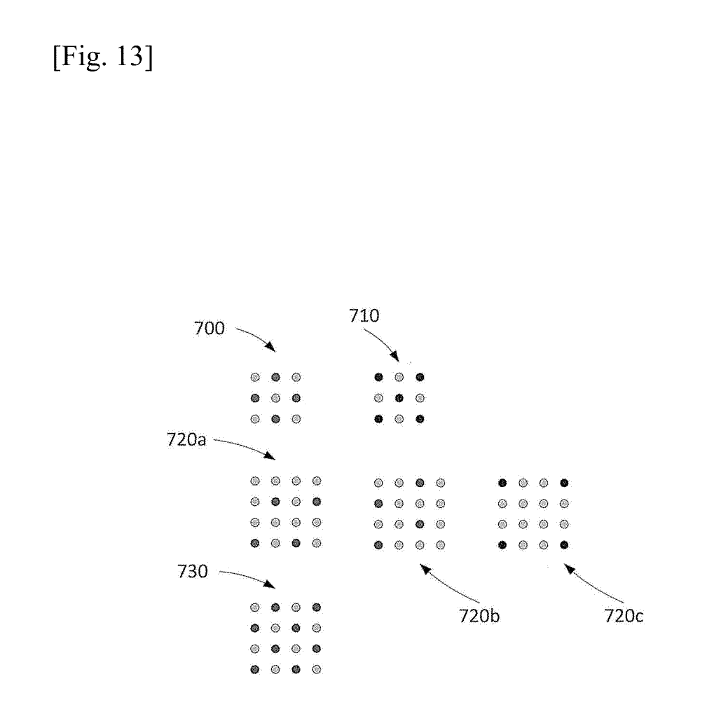

FIG. 13 illustrates a plurality of beam sub-sampling patterns, according to an embodiment of the present invention. The sub-sampling patterns are examples of patterns that efficiently cover the beam space to provide good performance.

A first pattern 700 is illustrated that shows a selection of 4 beams from a 3×3 grid of beams, and a second pattern 710 is illustrated that shows a selection of 5 beams from a 3×3 grid of beams.

A third 720a, a fourth pattern 720b, and a fifth pattern 720c show selections of 4 beams from a 4×4 grid of beams.

Finally, a sixth pattern 730 shows a selection of 8 beams from a 4×4 grid of beams.

According to certain embodiments, further generalization of the above design is possible, which maybe more suitable for the case where the antenna ports have a cross-polarized critically spaced URA configuration, as discussed above, or where two sets of correlated antennas are arranged in uniform rectangular array and the two sets are uncorrelated, similarly discussed above. Such generalisation of the codebook design is not, however, restricted to such configurations.

The first stage codebook in one dimension

C_{1H} can be represented as

C_{1H}={W1_{H}^{(k)};k=0,1, . . . ,N_{1H}−1}

where each codeword W1_{H}^{(k)} is expressed as

$$W {1}_{H}^{( k )} = [ \begin{matrix}{X}_{H}^{( k )} & 0 \\ 0 & {X}_{H}^{( k )}\end{matrix} ]$$

$${X}_{H}^{( k )} = ⌊ {b}_{{\tilde{a}}_{1} ( k )} {b}_{{\tilde{a}}_{2} ( k )} … {b}_{{\tilde{a}}_{{A}_{H}} ( k )} ⌋$$

where elements of bₙ is given by,

bₙ[m]=\tilde{b}ₙ[m];n=0,1, . . . ,Q_{1H};m=0,1, . . . ,(n_{TH}−1)

\tilde{b}ₙ[m]=e^{j2πnm/Q}^{_{1H}};n,m=0,1, . . . ,Q_{1H}

The first stage Codebook in another dimension

C_{1V} can be represented as

C_{1V}={W1_{V}^{(k)};k=0,1, . . . N_{1V}−1}

where each codeword W1_{V}^{(k)} is expressed as

$$W {1}_{V}^{( k )} = [ \begin{matrix}{X}_{V}^{( k )} & 0 \\ 0 & {X}_{V}^{( k )}\end{matrix} ]$$

$${X}_{V}^{( k )} = ⌊ {c}_{{\overline{a}}_{1} ( k )} {c}_{{\overline{a}}_{2} ( k )} … {c}_{{\overline{a}}_{{A}_{V}} ( k )} ⌋$$

elements of cₙ is given by,

cₙ[m]=\tilde{c}ₙ[m];n=0,1, . . . ,Q_{1B};m=0,1, . . . ,(n_{TV}−1)

\tilde{c}ₙ[m]=e^{j2πn,m/Q}^{_{1V}};n,m=0,1, . . . ,Q_{1V}

The Khatri-Rao product W1_{V}^{(m)}*W1_{H}^{(k)} can be represented as

$$W {1}_{V}^{( m )} * W {1}_{H}^{( k )} = [ \begin{matrix}{X}_{V}^{( m )} ⊗ {X}_{H}^{( k )} & 0 \\ 0 & {X}_{V}^{( m )} ⊗ {X}_{H}^{( k )}\end{matrix} ]$$

Thus W1_{V}^{(m)}*W1_{H}^{(k)} is an 2n_{TV}n_{TH}×2A_{V}A_{H} shaped matrix. It represents 2D beamforming by two sets of

n_{TV}n_{TH} correlated antennas to form two sets of A_{V}A_{H}
2D grid of beams each corresponding to the beamforming vectors c_{ā}_{ⱼ}₍ₘ₎⊗b_{ã}_{ᵢ}₍ₖ₎,
j=1, 2, . . . , A_{V}; i=1, 2, . . . , A_{H}.

A beam selection matrix, E is a block diagonal matrix and is configured by higher layer, i.e.

$$E = [ \begin{matrix}\overline{E} & 0 \\ 0 & \overline{E}\end{matrix} ]$$

where Ē has dimension A_{V}A_{H}×n_{B} and each column c is
eᵢ, i=1, 2, . . . , A_{V}A_{H}.
Here eᵢ represents a vector with all zero element except for the ith element which is a one.

The second stage Codebook

C₂ can be represented as

C₂={W2⁽ⁿ⁾;n=0,1, . . . N₂−1}

where each column c of W2⁽ⁿ⁾.
W2_{c}⁽ⁿ⁾ corresponds to the precoding vector applied to the cth layer.

It has the following structure

$$W {2}_{c}^{( n )} = [ \begin{matrix}{e}_{i} \\ α {e}_{i}\end{matrix} ] , i = 1 , 2 , … , {A}_{V} {A}_{H} , α ∈ Q$$

where α is from a constraint alphabet set Q and eᵢ represents
a vector with all zero element except for the ith element which is a one.
Thus for each layer, W2⁽ⁿ⁾ selects one beam direction
from the beam directions in W1_{V}^{(m)}*W1_{H}^{(k)}
and coherently combines the beams from
each set of n_{TV}n_{TH} transmit antennas.

In order to keep the codebook size reasonable, not all possible W2_{c}⁽ⁿ⁾ with the above structure need to be included in the codebook. Also to reduce the complexity, a further constraint of nested property is considered.

The final precoding matrix W can be expressed as,

W=(W1_{V}^{(m)}*W1_{H}^{(k)})×E×W2⁽ⁿ⁾ (Equation 4)

where W1_{V}^{(m)}∈C_{1V}
is the first stage codeword matrix corresponding to the first sub-PMI for the first dimension,
W1_{H}^{(k)}∈C_{1H} is the first stage codeword matrix corresponding to the second sub-PMI for the second dimension and W2⁽ⁿ⁾∈C₂ is the second stage codeword matrix corresponding to the third sub-PMI.

A*B

represents the Khatri-Rao product of two partitioned block matrices A and B.

The 3D codebook designs described above enable flexible and network configurable PMI reporting. According to certain embodiments of the present invention, a network may configure a UE to report the first sub-PMI, the second sub-PMI, and the third sub-PMI at different configurable periods upon observing a change in channel conditions due to a particular UE movement.

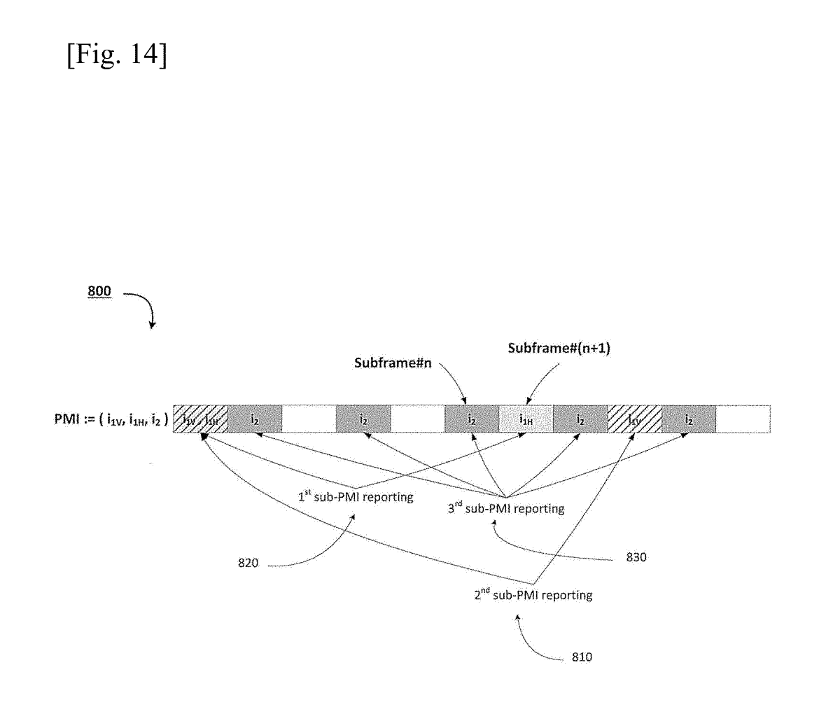

FIG. 14 illustrates a reporting configuration 800, according to a certain embodiment of the present invention. First sub-PMIs 820 and second sub-PMIs 810 are reported at different frequencies. In particular, the second sub-PMIs 810 are reported less frequently than the first sub-PMIs 820. When the first sub-PMI is used to track the channel in the vertical dimension and the second sub-PMI is used to track the channel in the horizontal dimension, then it is often advantageous to report the first sub-PMI less frequently than the second sub-PMI as an advanced UE is generally horizontal. Furthermore, both first and second sub-PMI 820,810 are generally reported less frequently than the third sub-PMI 830.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

Further, modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

What is claimed is:

1. A method of data communication in a wireless communication system, the wireless communication system including a base station comprising a plurality of antennas arranged in an array of at least two dimensions, the method including:
receiving, at a user equipment (UE) and from a set of the plurality of antennas, a plurality of reference signals, wherein the set of antennas includes antennas arranged in two spatial dimensions;
deriving channel estimates based on at least one received reference signal of plurality of reference signals;
selecting at the UE based on the channel estimates, a precoding matrix from at least one configurable precoding codebook by applying an associated configurable precoder function to matrices in the configurable precoding codebook; and
transmitting, from the UE to the base station, the channel information, wherein the channel information includes an identifier of the selected precoding matrix.

2. The method of claim 1, wherein
selecting the precoding matrix comprises selecting a first stage matrix from a first stage codebook; and selecting a second stage matrix from a second stage codebook, wherein
the associated precoder function includes a beam sub-selection function which produces an output matrix by removing one or more entries of an input matrix; and
selecting the first stage matrix includes applying the beam sub-selection function to matrices in the first stage codebook to form the precoding matrix.

3. The method of claim 2, wherein
the first stage codebook comprises first and second sub-codebooks.

4. The method of claim 3, further comprising:
generating a precoder, wherein
generating the precoder comprises:
forming an intermediate matrix from a selected matrix from the first sub-codebook and a selected matrix from the second sub-codebook; and
applying the beam sub-selection function to the intermediate matrix.

5. The method of claim 4, wherein
the intermediate matrix (W1ᵢₙ) is formed according to:
W1ᵢₙ=W1_{V}×W1_{H}
where W1_{V} is the selected matrix from one sub-codebook and W1_{H} is the selected matrix from the other sub-codebook, and x is one of a Kronecker product and a Khatri-Rao product.

6. The method of claim 4, wherein
the beam sub-selection function, f, is formed according to:
W1ₒᵤₜ=f(W1ᵢₙ)=W1ᵢₙ*E
where, * is matrix multiplication, W1ᵢₙ is the intermediate matrix from the first stage codebook, W1ₒᵤₜ is a matrix defining the first stage codebook precoder, and E is a column selection matrix.

7. The method of claim 4, wherein
the precoder comprises a precoding matrix and the precoding matrix, W, is formed according to:
W=f(W1ᵢₙ)*W2
where, * is matrix multiplication, W1ᵢₙ is the intermediate matrix from the first stage codebook, W2 is a matrix selected from the second stage codebook and f is the beam sub-selection function.

8. The method of claim 4, wherein
the precoder (W) is determined according to
W=(W1_{V}^{(m)}*W1_{H}^{(k)})×E×W2⁽ⁿ⁾
where W1_{V}^{(m)}∈C_{1V}
is a first stage codeword matrix corresponding to a first dimension, and C₁ᵥ is a first sub-codebook of a first stage codebook; W1_{H}^{(k)}∈C_{1H} is a first stage codeword matrix corresponding to a second dimension, and C_{1H} is a second sub-codebook of a first stage codebook; W2⁽ⁿ⁾ ∈C₂ is a second stage codeword matrix and C₂ is a second stage codebook; and * represents the Khatri-Rao product.

9. The method of claim 3, wherein
the channel information comprises first sub-channel information corresponding to the first stage codebook and second sub-channel information corresponding to the second sub-codebook.

10. The method of claim 9, wherein
the first sub-channel information is reported at a first rate and the second sub-channel information is reported at a second rate.

11. The method of claim 9, wherein
the first sub-channel information is used to track a long term or wideband channel state in a first spatial dimension, and the second sub-channel information is used to track the long term or wideband channel state in a second spatial dimension.

12. The method of claim 11, wherein
the channel information further comprises third sub-channel information for tracking a short-term or sub-band channel state in a reduced dimension channel.

13. The method of claim 12, wherein
the third sub-channel information is reported at a higher rate than the first and second sub-channel information.

14. The method of claim 3, wherein
the first and second sub-codebooks are Discrete Fourier Transform (DFT) based codebooks.

15. The method of claim 1, wherein
the set of antennas comprises the plurality of antennas.

16. The method of claim 1, wherein
the set of antennas comprises a subset of the plurality of antennas.

17. The method of claim 16, further comprising:
informing the UE of the subset of antennas.

18. The method of claim 16, further comprising:
grouping the plurality of antennas into a plurality of correlated sets; and
selecting the subset of antennas from one row and one column from each of the plurality of correlated sets.

19. The method of claim 18, wherein
the plurality of correlated sets include a first set having a first polarization, and a second set having a second polarization.

20. The method of claim 18, wherein
the subset of antennas are equally spaced along the one column and the one row.

21. A base station, comprising:
a plurality of antennas arranged in an array of at least two dimensions;
a processor coupled to the plurality of antennas; and
a memory coupled to the processor, the memory including instruction code executable by the processor for:
transmitting, from a set of the plurality of antennas, a plurality of reference signals, wherein the set of antennas includes antennas arranged in two spatial dimensions;
receiving, from a UE, channel information relating to the set of antennas, wherein the channel information was generated at least in part according to a reference signal of the plurality of reference signals;
generating a precoder using at least the channel information, at least one precoding codebook, and a precoder function; and
transmitting data to the UE using the precoder.

22. A user equipment (UE), comprising:
at least one antenna;
a processor coupled to the antenna; and
a memory coupled to the processor, the memory including instruction code executable by the processor for:
receiving, at the at least one antenna and from a set of antennas, a plurality of reference signals, wherein the set of antennas includes antennas arranged in two spatial dimensions;
deriving channel estimates based on at least one received reference signal of plurality of reference signals;
selecting based on the channel estimates a precoding matrix from at least one configurable precoding codebook by applying an associated configurable precoder function to matrices in the configurable precoding codebook;
generating, by the processor, channel information including an identifier of the selected precoder matrix; and
transmitting, from the at least one antenna and to a base station, the channel information.

23. A non-transitory computer readable storage medium storing a program for a base station that comprises a plurality of antennas arranged in an array of at least two dimensions and a processor coupled to the plurality of antennas, the program causing the processor to execute:
transmitting, from a set of the plurality of antennas, a plurality of reference signals, wherein the set of antennas includes antennas arranged in two spatial dimensions;
receiving, from a UE, channel information relating to the set of antennas, wherein the channel information was generated at least in part according to a reference signal of the plurality of reference signals;
generating a precoder using at least the channel information, at least one precoding codebook, and a precoder function; and
transmitting data to the UE using the precoder.

24. A non-transitory computer readable storage medium storing a program for a user equipment (UE) that comprises at least one antenna and a processor coupled to the antenna, the program causes the processor to execute:
receiving, at the at least one antenna and from a set of antennas, a plurality of reference signals, wherein the set of antennas includes antennas arranged in two spatial dimensions;
deriving channel estimates based on at least one received reference signal of plurality of reference signals;
selecting based on the channel estimates a precoding matrix from at least one configurable precoding codebook by applying an associated configurable precoder function to matrices in the configurable precoding codebook;
generating, by the processor, channel information including an identifier of the selected precoder matrix; and
transmitting, from the at least one antenna and to a base station, the channel information.
